(19) United States
(12) Patent Application Publication
(10) Pub. No.: US 2024/0280208 A1
(43) Pub. Date: Aug. 22, 2024

(54) HOSE BUMPER FOR HYGIENIC AND ASEPTIC HOSE ASSEMBLIES

(71) Applicant: Dixon Valve & Coupling Company, LLC, Chestertown, MD (US)

(72) Inventor: Austen Hinton, Mukwonago, WI (US)

(21) Appl. No.: 18/424,053

(22) Filed: Jan. 26, 2024

Related U.S. Application Data
(60) Provisional application No. 63/447,369, filed on Feb. 22, 2023.

(51) Int. Cl. F16L 57/06

(52) U.S. Cl. CPC F16L 57/06

(57) ABSTRACT

A hose bumper for a hose assembly is provided. The hose has an end fitting with an annular end flange forming a free end thereof remote from the hose. The hose bumper connects to the end fitting and is slidable on the end fitting from an extended position to a retracted position. The end flange is located within an interior of the hose bumper, when the hose bumper is in said extended position, and the end flange is exposed and extends exterior of the hose bumper, when the hose bumper is in the retracted position.

### CROSS REFERENCE TO RELATED APPLICATIONS

This application claims the benefit under 35 USC § 119(e) of U.S. Provisional Patent Application No. 63/447,369 filed Feb. 22, 2023.

### BACKGROUND

The present invention relates to food grade and aseptic hose assemblies used extensively in the food, beverage, winery, brewery, and pharmaceutical industries to transfer product in a hygienic or aseptic processing environment. More particularly, the present invention relates to a protective collar or bumper for a hose and to a hose assembly including such collar or bumper.

It is conventional practice to use hose assemblies in the transfer of fluids and other products from one area to another within a processing plant or the like. By way of example, a conventional hose assembly 10 is shown in FIG. 1. The hose assembly 10 includes a rubber or plastic hose or conduit 12 which is typically flexible. The hose 12 includes a hygienic fitting 14 on one or both ends thereof.

Each fitting 14 is typically constructed of 300 series stainless steel. Alternatively, the fittings 14 can be constructed of other materials, such as approved plastics, other metals, or the like. Typically, each fitting 14 is attached to the hose 12 by means of a sleeve 16 that is crimped over the outer diameter (OD) of the hose 12 and onto the fitting 14. The sleeve 16 may be provided within a range of diameters depending upon the diameter of a particular hose.

The fittings 14 play an important role in the sanitary design of the hose assembly 10 and damage to the fittings 14, i.e., dents, scratches, etc., can create potential bacteria traps that may lead to contamination issues in processing product. Such hose assemblies 10 are often connected and disconnected many times each day and are often dropped and dragged on concrete floors or the like in the processing facilities. This can result in damage to the fittings 14 and contamination thereof.

It is known to attach a protective, donut-shaped, rubber or plastic collar around the exterior of a hose to protect the hose. As discussed above, protection may be needed when a hose may become dragged across the ground or when it is desired to keep a hose raised off the ground to prevent the hose from contacting contaminants or the like. In particular, a collar or bumper may be used to protect the end fittings of a hose from being damaged. As an example of a hose donut, see U.S. Pat. No. 9,470,354 B2 issued to Boyanich.

Known bumpers, collars or donuts typically only provide partial protection of a fitting. For instance, the bumper is maintained in a stationary position at its installed position on the hose or fitting. However, such a bumper cannot be moved to cover the most critical part of the fitting which is the end of the fitting that physically connects to a mating fitting. Thus, if a hose is dropped at an extreme angle or hits another object prior to contacting the ground, the bumper cannot protect the end of the fitting from being damaged. By way of example, FIG. 2 shows a conventional arrangement of a hose 18 having a fitting 20 connected to a mating fitting 22 by means of a gasket and clamp 24. A bumper cannot necessarily cover the end of the fitting 20 or it would prevent a proper connection of fitting 20 to mating fitting 22.

### SUMMARY

A hose bumper for a hose assembly is provided. The hose has an end fitting with an annular end flange forming a free end thereof remote from the hose. The hose bumper connects to the end fitting and is slidable on the end fitting from an extended position to a retracted position. When the hose bumper is in the extended position, the end flange is located within an interior of the hose bumper and, when the hose bumper is in the retracted position, the end flange is exposed and extends exterior of the hose bumper.

### BRIEF DESCRIPTION OF THE DRAWINGS

FIG. 1 is a perspective view of a prior art hose assembly.

FIG. 2 is a perspective view of a prior art hose assembly connecting to a matting fitting with a clamp.

FIG. 3 is an exploded perspective view of an end of a hose assembly including a hose bumper in accordance with an embodiment.

FIG. 4 is an enlarged perspective view of the hose fitting of FIG. 3.

FIG. 5 is an enlarged perspective view of the hose bumper of FIG. 3.

FIG. 6 is a cross-section view taken longitudinally of a hose assembly including a hose bumper in accordance with an embodiment.

FIG. 7 is a perspective view of the hose bumper of FIG. 6 in an extended position in accordance with an embodiment.

FIG. 8 is a perspective view of the hose bumper of FIG. 6 in a retracted position in accordance with an embodiment.

FIG. 9 is an enlarged cross-section view of an upper portion of FIG. 6.

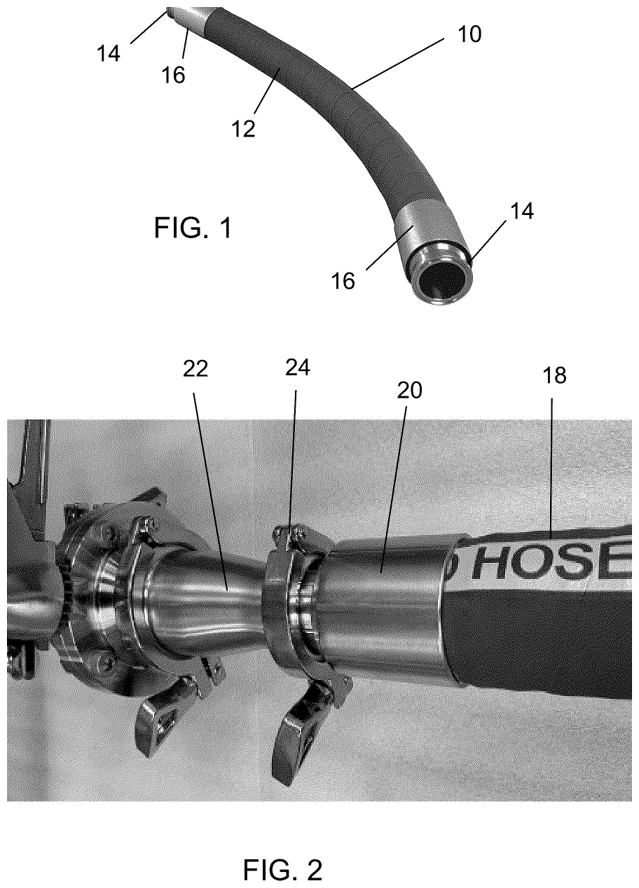

### DETAILED DESCRIPTION

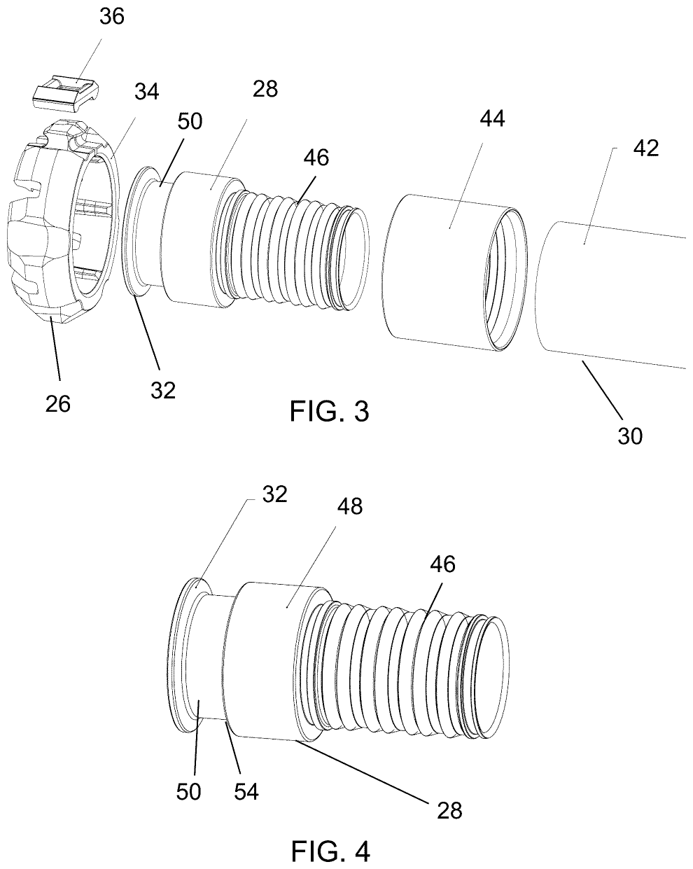

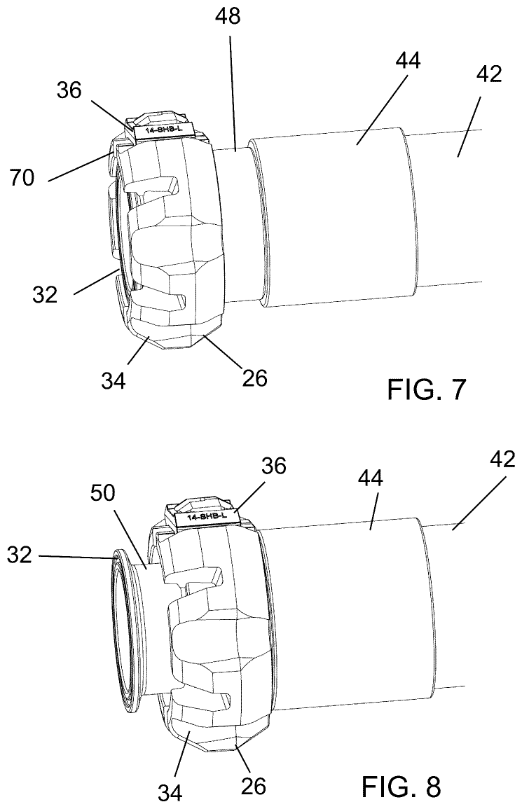

According to an embodiment, a protective bumper, collar, or donut 26 (see FIGS. 3 and 5-9) is provided that has a central opening for receiving an end fitting 28 of a hose and that can be moved between two positions on the fitting 28 depending upon how the hose assembly 30 is being used. For instance, when the hose assembly 30 is connected to a mating fitting or the like, the bumper 26 is positioned in a retracted position as shown in FIG. 8 (i.e., in a position spaced farthest from a connecting or mating fitting) so that a proper connection with the mating fitting is possible. Alternatively, when the fitting 28 is in a disconnected and free condition, the bumper 26 is moved to an extended position as shown in FIG. 7 to cover and protect the end flange 32 of the fitting 28 from damage or the like.

The bumper 26 may include a bumper body 34 constructed of plastic, an elastomeric material, a composite material, a wooden or metal material, or any other material and can be constructed as a single piece or may include multiple sections that are connected together such as provided by a two-piece or other multiple-piece design. A one-piece design is shown in FIG. 3.

As shown in FIG. 3, the bumper 26 may include a latch member 36 that, when installed on the bumper body 34, enables the bumper body 34 to exert a compressive force on the hose fitting 28. The latch member 36 may be made of rubber, an elastomeric material, plastic, or like material. The bumper 26 has an outer diameter surface 38 that is the portion of the bumper 26 that will contact the floor or the like, if the hose is dropped, and an inner diameter surface 40 that surrounds and engages an outer surface of the hose fitting 28.

As shown in FIG. 3, the hose assembly 30 includes a hose 42 (such as a rubber, plastic or like hose), the fitting 28 (such as a sanitary stem fitting made of stainless steel), and a sleeve 44 used to crimp the fitting 28 to an end of the hose 42. As best shown in FIG. 4, the fitting 28 includes a hose insertion section 46 for being inserted into the end of the hose 42 and crimped to the hose opposite the sleeve 44. See FIG. 6. The fitting 28 also includes an annular stem section 48 that extends from the hose insertion section 46 exteriorly of the hose 42 and that has an outer diameter larger than that of the hose insertion section 46 of the fitting 28. The fitting 28 further includes an annular groove or recess 50 for providing space for receiving a portion of a clamp or connector and an annular end flange 32 at the free end of the fitting 28 that provides a mating surface for a mating fitting or the like and that can become captured by the clamp or connector. Thus, the annular groove 50 is defined by the annular end flange 32 on one end and an edge 54 of the annular stem section 48 at the other end.

The bumper body 34 which connects to the fitting 28 may include one or more of the following features.

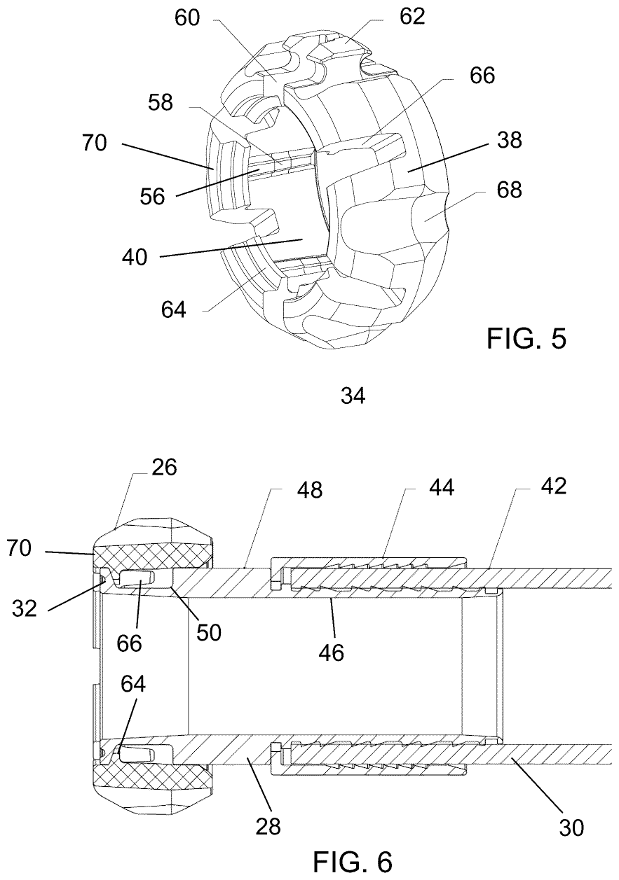

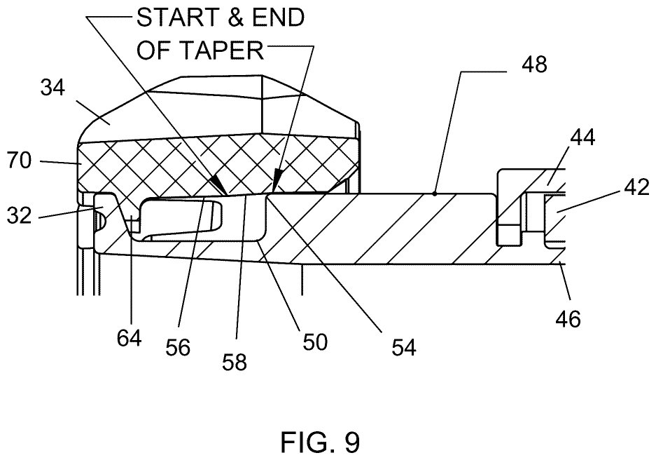

The bumper body 34 may include a series of spaced-apart rails 56 provided on the inner diameter surface 40 of the bumper body 34. The rails 56 may extend in a generally longitudinal direction and may directly contact the annular stem section 48 of the fitting 28. See FIGS. 5 and 6. The rails 56 reduce a frictional force existing between the bumper body 34 and the fitting 28 by reducing the amount of contact surface area between the bumper body 34 and the fitting 28. This allows the bumper 26 to be readily moved between the extended position (see FIG. 7) and retracted position (see FIG. 8) on the fitting 28 without a significant amount of force required to be exerted by the user. A purpose of the rails 56 is also to retain the bumper 26 in the extended position until the user applies a sufficient pre-determined amount of force required to move and re-position the bumper 26 to the retracted position. Each rail 56 may have a tapered inner face 58 that engages against the outer edge 54 of the annular stem section 48 of the fitting 28. For example, see FIG. 9.

The bumper body 34 may include one or more open slots or splits extending laterally through the bumper body 34. For instance, as shown in the embodiment of FIG. 5, the bumper body 34 has a single opening or split 60 extending laterally through the bumper body 34 that thereby allows the bumper body 34 to be provided as a single piece while also allowing the bumper body 34 to be flexed open or closed about the fitting 28. Thus, the split or opening 60 interrupts the otherwise continuous annular shape of the bumper body 34. Accordingly, the bumper body 34 can be flexed to a more spread apart condition to permit the bumper 26 to be placed onto or removed from the fitting 28. Likewise, the bumper body 34 can be permitted to resiliently close about the fitting 28 such that it remains attached to and captured on the fitting 28.

The latch member 36 can be installed on opposed portions 62 of the bumper body 34 that extend radially outward adjacent the split 60. See FIG. 5. The opposed portions 62 may be in form of prongs or hooks providing a structure about which the latch member 36 can be retained. When installed on the opposed portions 62, such as shown in FIGS. 7 and 8, the latch member 36 is placed in tension to compress the bumper body 34 at the split 60 to thereby enable the bumper body 34 to apply a compressive force on the fitting 28. This compressive force applied by the bumper body 34 on the fitting 28 in combination with the taper of the rails 56 keeps the bumper 26 in the extended position as shown in FIGS. 6, 7 and 9 to protect the free end of the fitting 28, including the end flange 32.

When force is applied by the user to the bumper 26 to move the bumper 26 to the retracted position as shown in FIG. 8, the bumper body 34 flexes open due to a widening of the split 60 thereby creating additional tension in the latch member 36. After the tapered inner faces 58 of the rails 56 of the bumper body 34 extend beyond the free edge 54 of the stem section 48 of the fitting 28, the bumper 26 will remain in the retracted position without the aid of any external forces to keep it there. To return the bumper 26 to the extended position from the retracted position, the user slides the bumper 26 toward the extended position and after the tapered inner faces 58 of the rails 56 reach the edge 54 of the stem section 48, the bumper body 34 snaps completely back to the extended position.

The rails 56 also provide space between the inner diameter surface 40 of the bumper body 34 and the stem section 48 of the fitting 28 on which the bumper body 34 rests. The purpose of this space is to allow for cleaning between the bumper body 34 and the fitting 28. This area can be sprayed down easily to remove any contaminates and the bumper 26 can be rotated easily on the fitting 28 to agitate the surfaces that need to be cleaned.

The inner diameter surface 40 of the bumper body 34 can include one or more inward-extending tabs 64 that are aligned circumferentially near a front face 70 of the bumper body 34. See FIGS. 5, 6 and 9. The tabs 64 are spaced a sufficient distance from the front face 70 of the bumper body 34 to permit the end flange 32 of the fitting 28 to be received within the bumper body 34 when the end flange 32 abuts against the tabs 64. For instance, see FIGS. 6, 7 and 9. In this position, the bumper 26 is able to protect the end flange 32 from damage.

The opening or split 60 in the bumper body enables the bumper body 34 to initially be flexed open so that the inward-extending tabs 64 can fit over the end flange 32 at the free end of the fitting 28. Thereafter, the tabs 64 extend within the groove 50 of the fitting 28 and are captured between the end flange 32 and edge 54 of the stem section 48 of the fitting 28. In addition, the tabs 64 in the captured position enable the bumper 26 to remain locked on the fitting 28 during use cases such as when the hose assembly is being dragged across a floor. Thus, unlike conventional bumpers, which can be pulled off a fitting due to forces experienced when a hose is dragged across a floor, the captive tabs 64 of the bumper 26 allow the bumper body 34 to remain locked on the fitting 28 despite forces being applied thereto.

The bumper body 34 may include several partial slots 66 formed therein. As best shown in FIG. 5, the partial slots 66 are open in the front face 70 of the bumper body 34 and extend longitudinally on the bumper body 34 through the tabs 64 to a location beyond the tabs 64 relative to the front face 70 of the bumper body 34. The partial slots 66 enable ready cleaning of an area between the bumper body 34 and the fitting 28. For instance, the slots 66 allow cleaning fluid to be directed at and reach all surfaces of the fitting 28 and allow for draining of any fluid that may otherwise be trapped between the fitting 28 and the bumper body 34.

The bumper body 34 may also include several spaced-apart relief cuts 68 formed in the outer diameter surface 38 of the bumper body 34 to reduce the wall thickness of the bumper body 34 in these areas allowing for the bumper body 34 to flex open or closed more easily when moved between the extended and retracted positions. Additionally, these areas provide an ergonomic grip for the user when needing to rotate the bumper 26 for cleaning and general operation.

As shown in FIGS. 6, 7 and 9, when the bumper 26 is provided in the extended position, the end flange 32 of the fitting 28 is housed fully within the bumper body 34 and is thus protected against damage when the hose assembly is 30 is carried or dragged across a floor or the like. In contrast, as shown in FIG. 8, when the bumper is provided in the retracted position, the end flange 32 and a portion of the groove 50 of the fitting 28 is exposed to permit a clamp or like connecter to be extended over the end flange 32 and into the groove 50 so that the hose assembly 30 can be connected to a desired mating fitting or the like. In the retracted position, the tabs 64 of the bumper body 34 can abut against the edge 54 of the stem section 48 within the groove 50 opposite the end flange 32.

By way of example, and not by way of limitation, the hose 42 of the hose assembly 30 may have an outer diameter of about 1 inch to about 6 inches. Thus, the bumper body 34 can be provided in a range of sizes to appropriately fit the fitting of an intended hose. Of course, larger or smaller hoses may be used and the bumper body 34 can be sized appropriated to fit such hoses and fittings.

The foregoing description and specific embodiments are merely illustrative of the principles thereof, and various modifications and additions may be made to the apparatus by those skilled in the art, without departing from the spirit and scope of this invention.

We claim:

1. A hose assembly, comprising:
a hose having an end fitting with an annular end flange forming a free end thereof remote from said hose;
a hose bumper connected to said end fitting and slidable on said end fitting from an extended position to a retracted position such that said end flange is located within an interior of said hose bumper, when said hose bumper is in said extended position, and said end flange is exposed and extends exterior of said hose bumper, when said hose bumper is in said retracted position.

2. The hose assembly according to claim 1, wherein said hose bumper includes a bumper body having an inward-facing surface that defines a central longitudinally extending opening extending through the bumper body and through which said fitting extends.

3. The hose assembly according to claim 2, wherein said inward-facing surface of said bumper body includes at least one inwardly extending rail for contacting said end fitting.

4. The hose assembly according to claim 3, wherein said at least one inwardly extending rail includes a plurality of spaced-apart inwardly extending rails.

5. The hose assembly according to claim 3, wherein said at least one rail extends longitudinally on said bumper body.

6. The hose assembly according to claim 5, wherein said at least one rail has a length, and wherein an inward extent of said rail tapers along at least a portion of said length.

7. The hose assembly according to claim 2, wherein said bumper body has at least one laterally extending opening that permits said bumper body to be flexed open to enlarge said central longitudinally extending opening and to be flexed closed to reduce said central longitudinally extending opening.

8. The hose assembly according to claim 7, further comprising a latch member that can be secured to said bumper body on opposed sides of said laterally extending opening to provide a resilient force to urge said bumper body into engagement with said end fitting.

9. The hose assembly according to claim 2, wherein said inward-facing surface includes at least one tab that extends inward and in a circumferential direction such that, when said hose bumper is in said extended position, said at least one tab abuts against said end flange of said end fitting which thereby captures said bumper body to said end fitting.

10. The hose assembly according to claim 9, wherein said end fitting has an annular stem section extending from the hose and a groove between said stem section and said end flange such that an outer diameter of said end fitting within said groove is less than an outer diameter of said end fitting at said stem section or said end flange and such that said at least one tab extends within said groove and is captured therein.

11. The hose assembly according to claim 10, wherein, when said hose bumper is in the retracted position, the at least one tab abuts against an edge of said stem section and is spaced from said end flange of said end fitting thereby exposing said end flange and a part of said groove of said end fitting.

12. A hose bumper for an end fitting of a hose, the end fitting having an annular end flange, comprising:
a bumper body connectable to the end fitting such that said bumper body is slidable on said end fitting from an extended position to a retracted position;
wherein said bumper body is configured such that, when said bumper body is in the extended position, the end flange of the end fitting is located within an interior of said bumper body and, when said bumper body is in said retracted position, the end flange of the end fitting is exposed and extends exterior of the bumper body.

13. The hose bumper according to claim 12, wherein said bumper body has an inward-facing surface that defines a central longitudinally extending opening extending through the bumper body.

14. The hose bumper according to claim 13, wherein said inward-facing surface of said bumper body includes at least one inwardly extending rail.

15. The hose bumper according to claim 14, wherein said at least one inwardly extending rail includes a plurality of spaced-apart inwardly extending rails.

16. The hose bumper according to claim 15, wherein rails extend for a length in a longitudinal direction on said bumper body, and wherein an inward extent of each of said rails tapers along at least a portion of said length.

17. The hose bumper according to claim 13, wherein said bumper body has at least one laterally extending opening that permits said bumper body to be flexed open to enlarge said central longitudinally extending opening and to be flexed closed to reduce said central longitudinally extending opening.

18. The hose bumper according to claim 17, further comprising a latch member that can be secured to said bumper body on opposed sides of said laterally extending opening to provide a resilient force to urge said bumper body toward a closed condition.

19. The hose bumper according to claim 13, wherein said inward inward-facing surface includes at least one tab that extends inward and in a circumferential direction.

20. The hose bumper according to claim 13 wherein said bumper body includes a series of slots extending partially through said bumper body from a front of said bumper body and a series of relief indentations on an outer face.
